(19) United States
(12) Patent Application Publication
(10) Pub. No.: US 2007/0038166 A1
(43) Pub. Date: Feb. 15, 2007

(54) Contact stimulus tool

(76) Inventor: Kathy L. Ulrich, Albuquerque, NM (US)

Correspondence Address: Kathy L. Ulrich, 10204 Ellen Ct. NE, Albuquerque, NM, 87112, US

(21) Appl. No.: 11/497,580

(22) Filed: Aug. 1, 2006

Related U.S. Application Data
(60) Provisional application No. 60/705,563, filed on Aug. 5, 2005.

(51) Int. Cl. A61H 7/00

(52) U.S. Cl. 601/135; 606/204

(57) ABSTRACT

The Contact Stimulus Tool is a modification of an entirely different tool, the Center Punch. The modifications to the tool allow it to be used by healthcare practitioners such as; massage therapists, physical therapists, acupressure and trigger point therapists. This has been achieved by, (refer to page 3 of drawings and the description pertaining to it) mechanically altering and adding necessary components to the existing tool. By doing so the inventor has developed a unique tool, which will help advance treatment techniques in the above-mentioned professions.

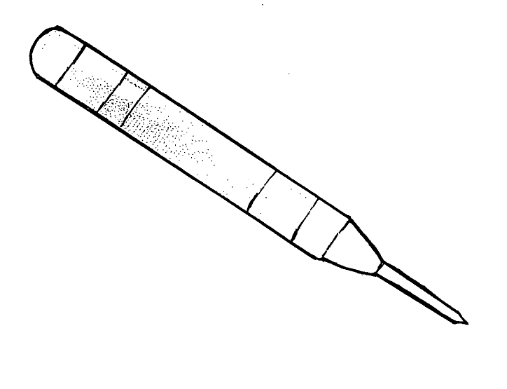

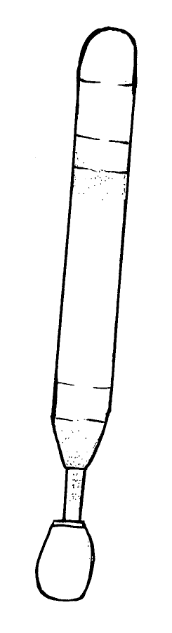

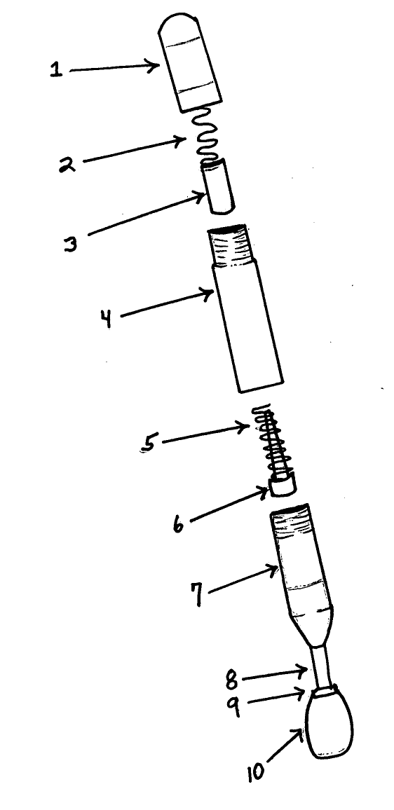

### BACKGROUND OF THE INVENTION

This dual-use tool is designed to be used by persons working in healthcare professions in which fingertip-pressure therapies are employed.

### BRIEF SUMMARY OF THE INVENTION

This dual-use, hand operated, soft tipped spring-loaded tool will produce a vibratory stimulus via the soft tip, to the point of contact. The tool may also be used to prevent gradual unintentional pressure increases during therapies requiring the application of less then 8 lbs per square inch of pressure.

### BRIEF DESCRIPTION OF THE SEVERAL VIEWS OF THE DRAWING

1. Page one of the drawings is the original center punch tool.

2. Page two of the drawings shows the finished “The Contact Stimulus Tool”

3. Page three of the drawings shows the exploded view of the tool.

### DETAILED DESCRIPTION OF THE INVENTION

The tool, (1-10, refer to page 3/3 of drawings) has the tip's shaft (8), turned down to 0.1252×0.350 allowing it to be pressed into the tip, (9) manufactured from 303 stainless steel, it is one half inch long by ⅜ inch in diameter with a ⅛ corner radius at one end and a 0.125 by ⅜ inch deep hole at the other to accept the shaft's tip (8). The radius end is covered with a ⅜-inch diameter plastic cap (10), for protection and softness. The springs (2&5), are manufactured from music wire astm-228 which is a high quality wire with a Rockwell hardness of c41-c60, with and outside coil diameter of 0.300, a 0.026 wire size, and a 3.00 pound maximum load. Their free length is 1½ inch, solid height of 0.288 inches and a spring deflection rate of 3.51 pounds per square inch. The parts numbered 1,3,4,6, and 7 are described in the above-referred patents and have not been modified by the inventor.

### Front Page View

Page 2/3 of the drawings would be the most suitable for the front page.

1. The tool's contact tip provides a circular contact surface of approximately fingertip size.

2. The tool will produce a sudden vibratory stimulus whenever the tool's operator delivers a thrust exceeding 8 lbs. per square inch of pressure into a contact point.

3. When pressures less than 8 pounds per square inch are required, the tool will produce audible and tactile signals before the tool's operator exceeds the 8 pounds per square inch limit.
